(19) United States
(12) Patent Application Publication
(10) Pub. No.: US 2008/0032275 A1
(43) Pub. Date: Feb. 7, 2008

(54) Interactive system

(76) Inventor: Yu Zheng, Walnut, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/491,358

(22) Filed: Jul. 21, 2006

(51) Int. Cl. G09B 5/00

(52) U.S. Cl. 434/317

(57) ABSTRACT

A interactive system and a method illustrates the subject matter of a book or a plurality of documents. The system has a housing assembly, a selector, and a video screen. A book or a plurality of documents are positioned in a receiving zone of the housing assembly in a manner in which at least one page of the book or plurality of documents is exposed and faces upwardly. The selector is then used to select a specific location on the exposed page, causing video images associated with the specific location to be displayed at the video screen.

### BACKGROUND OF THE INVENTION

1. Field of the Invention

The present invention relates to an interactive system, and to an interactive system that provides simultaneous audio and visual outputs to emulate a “live” experience.

2. Description of the Prior Art

There are a variety of interactive electronic book devices in which a book is placed on a platform. The platform includes a detection system where a generated response depends upon the portion of the book that is pointed to by a user-controlled stylus or pointing device. Such interactive books are configured to provide an audio output related to a stylus position. For example, an interactive book device for children may speak the words which are pointed to, or play games (or tell stories) when the child points at a picture. Examples of interactive book devices are illustrated in U.S. Pat. Nos. 5,575,659, 6,668,156 and 7,035,583, and in Pub. No. US2004/0043365.

Most of the known interactive book devices provide only audio output in response to a word or picture or region which is pointed at. Thus, the child or user only receives primarily an audio response, which is not always effective in creating or simulating a more “real” or “live” environment.

### SUMMARY OF THE INVENTION

It is an object of the present invention to provide an interactive book device that provides the user with a “live” experience.

In order to accomplish the above-described and other objects of the present invention, the present invention provides a system and a method of illustrating the subject matter of a book or a plurality of documents. The present invention provides an interactive system having a housing assembly, a selector, and a video screen. A book or a plurality of documents are positioned in a receiving zone of the housing assembly in a manner in which at least one page of the book or plurality of documents is exposed and faces upwardly. The selector is then used to select a specific location on the exposed page, causing video images associated with the specific location to be displayed at the video screen.

### BRIEF DESCRIPTION OF THE DRAWINGS

FIG. 1 is a perspective view of a system according to one embodiment of the present invention.

FIG. 2 is a schematic block diagram of the electronics of the system of FIG. 1.

FIG. 3 is a perspective view of a system according to another embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides an interactive system and a method for simulating a “live” experience for the user. The system can be embodied in the form of an interactive book device that simulates a “live” experience associated with the subject matter of the book, or of a plurality of documents.

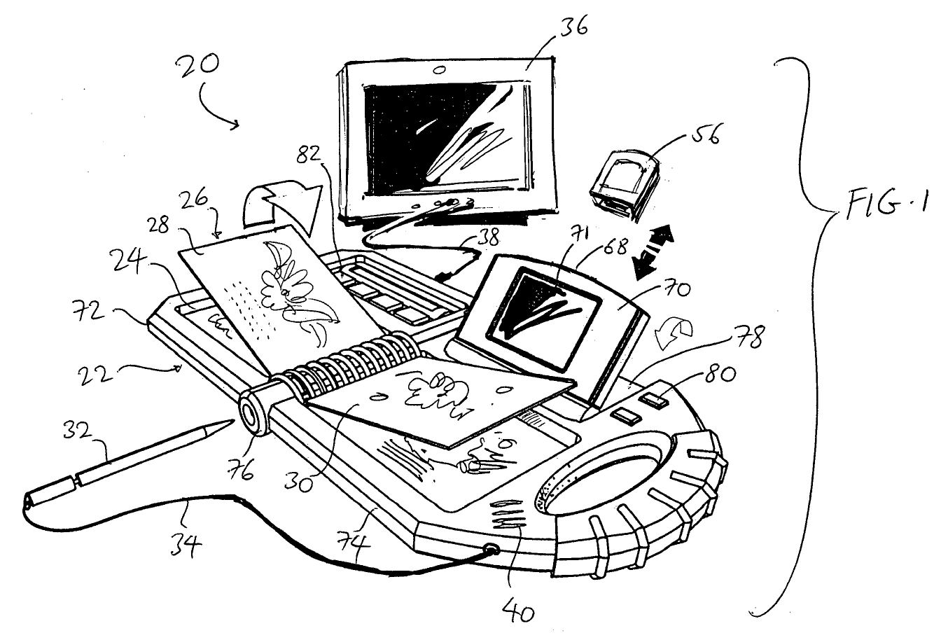

FIG. 1 illustrates an interactive system 20 according to one embodiment of the present invention. The system 20 includes a housing assembly that can be embodied in the form of a platform 22 having a receiving zone 24 that receives an open book 26, the topmost pages 28 and 30 of which are readable by a user. A selector, which can be a stylus 32, is coupled to the platform 22 via a wire 34, and a screen or visual display monitor 36 is also coupled to the platform 22 via a wired connection 38. As an alternative, the wired connections 34 and 38 can be replaced by wireless connection using wireless communication techniques that are well-known in the art.

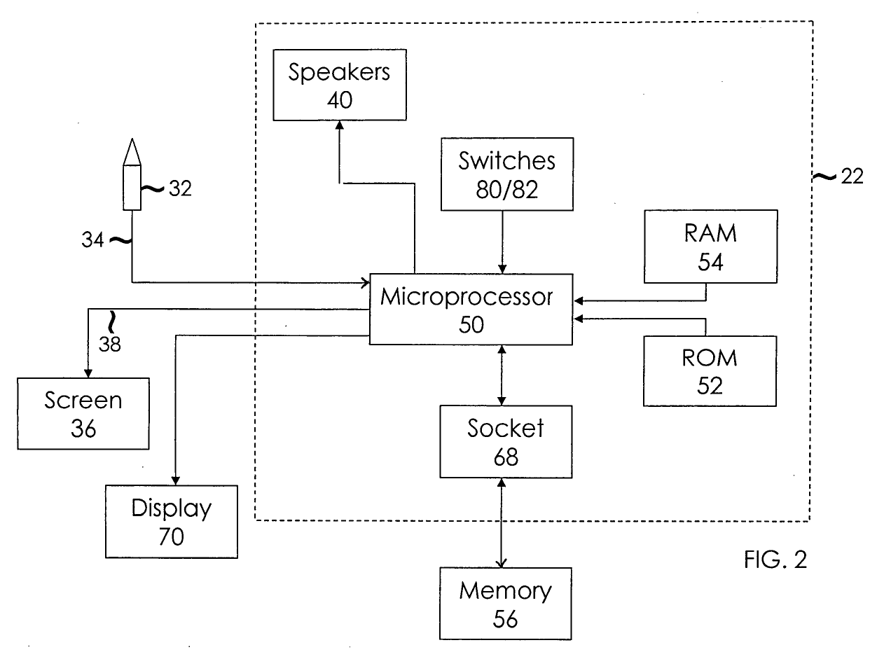

The platform 22 houses its associated electronics (see FIG. 2) and operates with the stylus 32 and the screen 36 to detect the area inside the receiving zone 24 to which the stylus 32 is pointed. As the user turns the pages of the book 26, the user uses the stylus 32 to point to particular words, pictures, symbols, images or patterns. As the user points to particular words, pictures, symbols, images or patterns, an audio output is emitted from a speaker 40 provided on the platform 22, and an image or streaming video is simultaneously played on the screen 36. In particular, the stylus 32 enables the co-ordinate location of that area to be determined by the platform 22, with the stylus 32 being (for example) magnetically or capacitatively coupled to the platform 22 through the pages of the book 26. The stylus 32 and the platform 22 may be embodied in the form of any of the conventional stylus and graphics tablets described in U.S. Pat. Nos. 5,575,659, 6,668,156 and 7,035,583, whose entire disclosures are incorporated by this reference as though set forth fully herein. In addition, the stylus 32 can be omitted and the system 20 can utilize a user's finger as a selector to detect the selected location, as described in Pub. No. US2004/0043365, whose entire disclosure is incorporated by this reference as though set forth fully herein.

The platform 22 is designed to accomodate any print medium. The print medium can take the form of books and single sheets. The single sheets can include paper, cards, placemats, and even gameboards. The book can have any binding or spine. In some embodiments, the platform 22 may have a detection mechanism to determine when a user turns a page of a book so that the microprocessor can be cued as to the page that the user is viewing. Examples of such page detection mechanisms are illustrated in U.S. Pat. Nos. 6,668,156 and 7,035,583, and in Pub. No. US2004/0043365, whose entire disclosures are incorporated by this reference as though set forth fully herein.

The receiving zone 24 may be sunken or recessed to define a receiving space into which a book 26 (or single sheets) can be snugly fitted, thereby ensuring that the position of the book 26 and its pages (or the single sheets) are consistently located in proper relationship to the programmed regions for the specific words, pictures, symbols, images or patterns. Consistent book positioning can also be accomplished by providing a slot to accomodate the binding of the book 26, or page notches to detect which pages or single sheets are being positioned in the receiving zone 24. Examples of such positioning mechanisms are illustrated in U.S. Pat. Nos. 6,668,156 and 7,035,583, whose entire disclosures are incorporated by this reference as though set forth fully herein.

Referring now to FIG. 2, the co-ordinate details of the pointed area are provided to a microprocessor 50, which operates under the control of a program stored in a memory 52 (e.g., a ROM). Another memory 54 (e.g., a RAM) stores the data addresses of the audio and video signals corresponding to the various areas of the page (i.e., sheet or book) being read. These audio and video signals can be stored in another memory 56. The microprocessor 50 outputs the data address to the memory 56, which provides the selected audio and video signals back to the microprocessor 50 to be subsequently transmitted to the speaker 40 and the screen 36 (via the wire 38).

The memory 56 can be provided inside the platform 22, or as a separate an external memory device such as a compact disk or cartridge that accompanies (or is sold with) the book 26 or sheet. If the memory 56 is provided in the form of an external memory device, then it can be coupled with the microprocessor 50 via an input/output (I/O) interface 68, which can be embodied in the form of a socket or port provided on an optional display 70 that has a screen 71.

An on-off switch 80, and other control switches (e.g., 82) can be provided on the platform 22. These swtiches 80, 82 and other control switches can be used to control the volume or other settings associated with the system 20.

The platform 22 can further include an optional display 70 that can be hingedly connected to the platform 22 so that the display 70 can be raised (as shown in FIG. 1) or pivoted into a recessed region 78 on the platform 22. The screen 71 on the display 70 can be used to display the same images as the screen 36, so that the screen 36 can be viewed by people other than the user while the user is viewing the display 70. Alternatively, the display 70 can be used to display instructions or other secondary or background images. For example, the screen 36 can be used to display images relating to a “real-life” event or experience, while written instructions can be separately and simultaneously displayed on the display 70 without detracting from the “real-life” experience provided by the screen 36 and the speaker 40.

The platform 22 can be foldable to reduce the overall size of the platform 22 for storage and transportation. The platform 22 can be divided into separate panels 72 and 74 that are connected by a hinged connection 76. A latch (not shown) or other locking mechanism can be provided on the panels 72, 74 to secure the panels 72, 74 together in a folded or closed orientation.

In use, the user turns on the system 20, and selects a desired book 26 and accompanying cartridge 56 (if applicable) to be read. The user positions the book 26 in the receiving zone 24 and inserts the cartridge 56 into the interface 68. The microprocessor 50 downloads the data from the selected cartridge 56 (or from the RAM 54 if the cartridge 56 is not used), and the system 20 detects the opened pages 28 and 30 using the page detection techniques referred to above. The user then selects words, pictures, symbols, images or patterns on the opened pages 28, 30 using the stylus 32 or his/her own fingers. The system 20 detects the selected words, pictures, symbols, images or patterns, and provides both a video output via the screen 36 and an audio output via the speaker 40. The audio and video output is based on the data stored in the selected cartridge 56 or the RAM 54.

For example, if the book 26 tells a story, then the video output can be in the form of streaming video images that simultaneously accompany the part of the story that is being read (i.e., transmitted in audio form via the speaker 40). This allows the reader to experience the story unfolding before him/her in a “live” manner, so that the system 20 provides the user with more than just an audio experience.

As another example, if the book 26 is an educational book about wildlife, then the video output can be in the form of streaming video images of the animals and wildlife that are associated with the words or animals selected by the user, to simultaneously accompany the audio part of the narrative or description that is being read (i.e., transmitted in audio form via the speaker 40). This allows the reader to have a more “real-life” experience of the subject matter that is being read to the user.

As yet another example, if the book 26 is an educational book that teaches the user how to cook a dish, or make an object, then the video output can be in the form of streaming video images of the steps of the cooking or making process that are associated with the words or images selected by the user, to simultaneously accompany the audio part of the narrative or description that is being read (i.e., transmitted in audio form via the speaker 40). This provides the user with a more accurate and “hands-on” learning experience.

In addition, if the screen 36 is a conventional television unit, then it is also possible to omit the speaker 40 from the platform 22, with the audio output being output from the speakers (not shown) in the television unit.

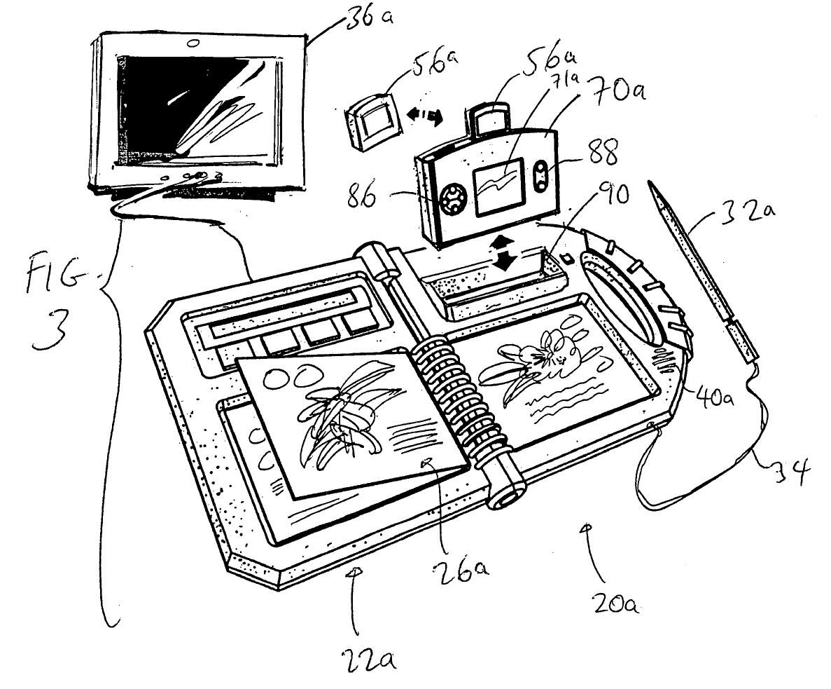

FIG. 3 illustrates a modification that can be made to the system 20 in FIG. 1.

In the system 20a in FIG. 3, the display 70 can be converted into a hand-held unit 70a that can be used separately from the system 20a for other functions. For example, the hand-held unit 70a can be used as a conventional game unit that has control buttons 86 and 88. The hand-held unit 70a can be received inside a receiving well 90 that is provided on the platform 22a. Thus, in this application, the system 20a would provide a combined interactive book device and game unit, with the separate game unit adapted to offer the user games that relate to the subject matter of the book 26a.

For example, if the book 26a is about an action hero, the cartridge 56a can store games that relate to the action hero. The user can use the stylus 32a to point to selected regions on the opened pages of the book 26a, and the speaker 40a and the screen 36a will provide simlutaneous audio and video output, respectively, regarding the story. The audio and video output can be provided from data stored in the RAM (e.g., 54) inside the platform 22a. In the mean time, the user can remove the hand-held unit 70a, insert a cartridge 56a, and play a video game relating to the action hero and the story being illustrated from the book 26a. Thus, the user can experience a complete “live” experience for the story by listening to (via the speaker 40a), viewing (via the screen 36a), and enacting (via the screen 71a on the hand-held unit 70a) the story.

As another example, if the book 26a is about wildlife, the cartridge 56a can store short video programs that relate to the different types of wildlife illustrated in the book. The user can use the stylus 32a to point to selected regions on the opened pages of the book 26a, and the speaker 40a and the screen 36a will provide simlutaneous audio and video output, respectively, regarding the selected animals. The audio and video output can be provided from data stored in the RAM (e.g., 54) inside the platform 22a. In the mean time, the user can remove the hand-held unit 70a, insert a cartridge 56a, and use the control buttons 86 and 88 to activate different programs relating to the selected animals. Thus, the user can experience a complete “live” experience for the wildlife by listening to (via the speaker 40a) and viewing a variety of programs (via the screen 36a and the hand-held unit 70a) relating to the selected animals.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An interactive electronic system, comprising:
a plurality of documents;
a housing assembly having a receiving zone that receives the plurality of documents in a manner in which at least one page of the plurality of documents is exposed and faces upwardly;
a selector that selects a specific location on the exposed page;
electronics housed in the housing;
a video screen coupled to the electronics, the video screen displaying video images associated with the specific location; and
wherein the electronics respond to the specific location selected by the selector and transmits to the video screen signals representative of the video images.

2. The system of claim 1, wherein the plurality of documents comprises a book.

3. The system of claim 1, wherein the housing assembly comprises a platform that includes two panels that are hingedly connected to each other.

4. The system of claim 1, further including a speaker provided in the housing assembly.

5. The system of claim 1, further including a memory that is removably coupled to the housing assembly.

6. The system of claim 1, wherein the electronics includes:
a processor;
a first memory that stores a program that controls the operation of the processor; and
a second memory that stores the data addresses of the video image signals corresponding to the specific locations.

7. The system of claim 1, further including:
a hand-held unit that has at least one control button and a screen; and
a cartridge having a memory that stores programs, the hand-held unit receiving the cartridge with the screen on the hand-held unit displaying images from the programs.

8. A method of illustrating the subject matter of a book or a plurality of documents, comprising:
a. providing an interactive system comprising:
a housing assembly having a receiving zone;
a selector; and
a video screen;
b. positioning the plurality of documents or book in the receiving zone in a manner in which at least one page of the plurality of documents or the book is exposed and faces upwardly;
c. using the selector to select a specific location on the exposed page; and
d. displaying at the video screen video images associated with the specific location.

9. The method of claim 8, wherein step (d) further includes:
simultaneously broadcasting audio output associated with the specific location.

10. The method of claim 8, further including:
providing a hand-held unit that has a control button and a screen; and
causing the screen on the hand-held unit to display images relating to the book or plurality of documents.
